(19) United States
(12) Patent Application Publication
(10) Pub. No.: US 2009/0106154 A1
(43) Pub. Date: Apr. 23, 2009

(54) Remote Deposit Gateway

(75) Inventors: Tim Reynolds, Colorado Springs, CO (US); David Schoenberger, Divide, CO (US)

Correspondence Address: NIKOLAI & MERSEREAU, P.A., 900 SECOND AVENUE SOUTH, SUITE 820, MINNEAPOLIS, MN, 55402, US

(73) Assignee: GUARDIAN PAYMENT SYSTEMS, LLC, St. Paul, MN (US)

(21) Appl. No.: 12/252,745

(22) Filed: Oct. 16, 2008

Related U.S. Application Data
(60) Provisional application No. 60/980,676, filed on Oct. 17, 2007.

(51) Int. Cl. G06Q 40/00

(52) U.S. Cl. 705/45; 705/39

(57) ABSTRACT

The remote deposit gateway is a payment management system designed to capture many types of payments and provide basic management tools for tracking and researching these payments. Payment capture of check images are used for Check 21 Act processing. Recurring checks allow scanned checks to be used on a recurring payment plan. Credit card payments can be entered for single or recurring payments. Management of returns and special notes for each item are allowed in the system. Batching of payments and checking sums is a feature of the system. The system employs a smart calendar program to track processing chronologically. Use of the system speeds up funds collection times, reduces collection costs and increases collection rates on returned items.

### BACKGROUND OF THE INVENTION

1. Field of the Invention

This invention relates to the management and processing of payments made by checks, credit cards or scheduled recurring payments and employs electronic financial transactions.

2. Description of the Related Art

Merchants who collect payments in several forms such as checks, credit card payments, recurring check payments and recurring credit card charges in large volumes need a way of managing payment processing to efficiently collect the money on these payment instruments as fast as possible and at the lowest cost to the merchant.

Merchants have used banks and paid fees to manage their collections, however, by using a remote deposit gateway system the merchant can use electronic funds transfers to reduce costs, increase collection rates and speed up the collection of funds.

### SUMMARY OF THE INVENTION

The Remote Deposit Gateway system is a payment processing application for businesses to use in their back office operations for capturing, depositing and managing payments. Use of the remote deposit gateway system speeds up collections, and reduces costs. The business can batch payments by type and electronically send the payment instruments for collection. Electronic collections speed up the process of getting paid and reduce the costs of collections. The application uses a calendar for tracking the status of the payment instruments and management of the collection process.

The application consists of modules to capture, index, verify, deposit and manage all types of payments. Each of these modules acts independently and is highly configurable and customizable.

The capture module allows for dynamically discoverable scanner adapters to be configured and used to capture front and back images of a document as well as the MICR code line at the bottom of a payment instrument such as a check or money order. The architecture of the capture module allows for use of any capture device. Additionally, a generic XML interface is provided that allows data from any upstream device to be captured and used as input for payments.

The index module is used to enter data into required and custom data fields based on the batch type that has been captured. An unlimited number of batch types can be defined, and each batch type can be configured to accept any number of user pre-defined fields. The index step allows for specific fields to be defined and validates certain special fields such as ABA routing number, credit card number and expiration date to ensure that they meet payment processor requirements. The order of the data entry is also configurable to maximize worker productivity. If verification or validation is configured (for credit cards or checks), a transaction cannot be accepted unless it passes the verification rules from the processor host.

The quality control module is used if a batch is configured for verification. A process is invoked for an operator to verify the data entered by the first operator. On a field-by-field basis, the batch can be configured to either show the original values entered by the indexer, or blank out the field to require a “blind-double-key”. The results of the two key entries are compared and differences must be resolved prior to the transaction being accepted. Batch types may also be configured to require a pre-key control total and count, and the final batch verification must match the pre-keyed information. Although two verification methods have been shown therein any method to verify entered data may be used.

The deposit module is used once batches are completed and are available for deposit. The operator responsible for making deposits can make a final check of the batches and exclude any individual transactions if needed. Any excluded transactions are then sent to a suspended batch to be resolved at a later time. Once a deposit is ready, any batches that are similar can be merged into a single deposit so that results can be tracked with the processing partner.

In the management module any transaction that has been captured can be used to create a scheduled recurring payment. A recurring payment is one that is made on a regular schedule once approval by the payer has been established. The information from the original transaction is supplemented with additional data and the payments are then scheduled on a periodic and regular basis. This feature dynamically builds the “next payment due” based on the business rules in force at each periodic payment cycle. This allows the operator to be able to maintain specific details right up to the day that a payment may be due and therefore the information is always correct and current. If, however, the operator generates the payments due for a day and then discovers that a change must be made, the operator can over-ride any specific item in the payment prior to the deposit step. This provides maximum flexibility in management of recurring payments.

The management module is also used for any payment item that is returned for non-payment from the processor. Such check item is duly noted in red on the screen and can easily be found by the operator. The reason for the return is noted and can be reported using ad-hoc reporting tools. Past payments can easily be researched, and if the original item was scanned, the original documents can be printed for research or documentation.

The Remote Deposit Gateway has a smart calendar for giving the operator a quick overview of all activity for selected periods of time. The calendar is color coded to show the status of collections for the day. When a day is selected, information about the number of payments, the number of deposits, the total dollar amounts processed, the number of batches processed and information about the items in the batches is available to allow for quickly obtaining information about payments and returns for the day. All images from checks and credit cards for a particular day can be accessed through the calendar.

The Remote Deposit Gateway allows capture of unique information and exports it along with the other payment details, using a format that external applications can utilize.

### OBJECTS OF THE INVENTION

It is an object of the invention to increase the collection rates of a business.

It is an object of the invention to reduce the costs of collections for a business.

It is an object of the invention to manage the collections process for a business.

It is an object of the invention to allow customers to select payment plans and methods of payment.

It is an object of the invention to allow customers to make recurring payments by check or credit card.

It is an object of the invention to allow data to be exported to other systems.

It is an object of the invention to provide a calendar driven data base and collections process.

It is an object of the invention to use program wizards to easily set up the remote deposit gateway software to the desired settings of the user.

It is an object of the invention to use a calendar as a management tool for accessing accounts, data bases and work loads.

Other objects, advantages and novel features of the present invention will become apparent from the following description of the preferred embodiments when considered in conjunction with the accompanying drawings.

### BRIEF DESCRIPTION OF THE DRAWINGS

FIG. 1 shows the home window for the calendar driven remote deposit gateway.

FIG. 2 shows the scanned check batch window screen.

FIG. 3 shows the single payments screen.

FIG. 4 shows a scanned check screen.

### DESCRIPTION OF THE PREFERRED EMBODIMENTS

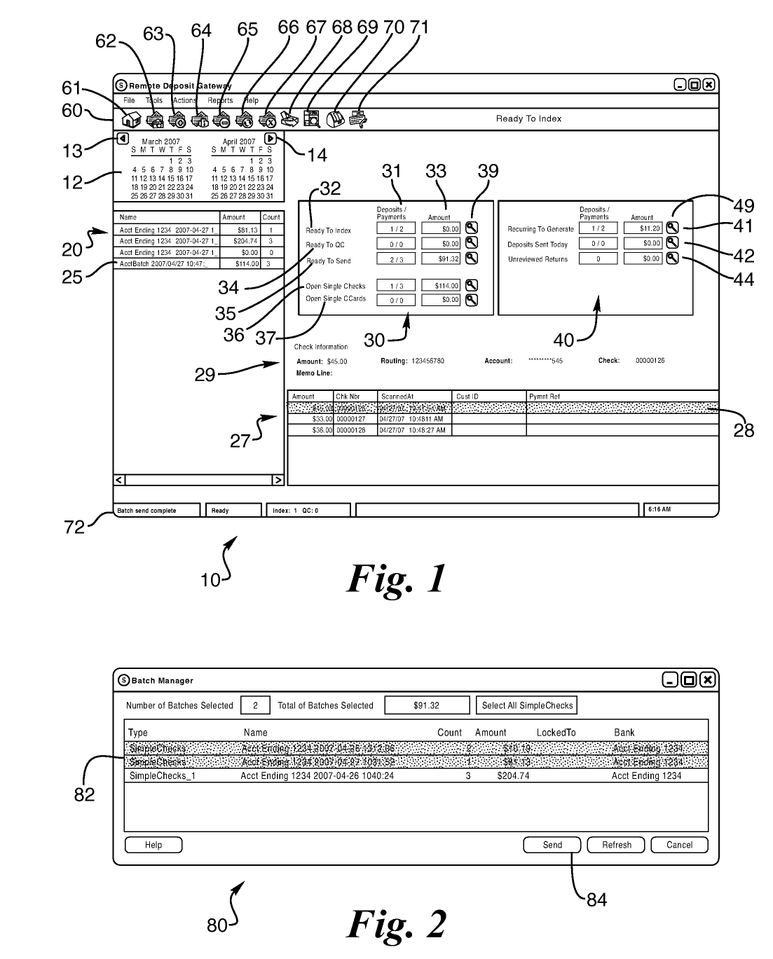

When the Remote Deposit Gateway software is installed in a merchant's computer system the merchant is allowed to choose color codes for the calendar 12 used on the home window 10 as shown in FIG. 1. The colors are used to convey information about the status of accounts at a glance. For example a day on the calendar 12 may be green representing a day for which all checks and credit card slips have been processed and deposits have been made with no returned items. This indicates, by a quick look at the calendar 12, that there are no further payment instruments to be processed for the day. A day on the calendar may be colored yellow indicating a day where not all payment instruments have been processed and the merchant will have to finish processing checks or credit card slips for that day. The merchant may wish to color days where no checks were received silver. A red day may be a day where un-reviewed returns have occurred, for example, if a payment has been returned as not collectable. The red day indicates a day where the merchant will have to review the payments to see which ones need to be further processed for collection. Once the day's uncollected payments have been reviewed the color for the day may be changed from red to orange indicating action has been taken on the returns for that day.

Once the color codes have been established an experienced user will know from a quick look at the color coded calendar what tasks are required for which days. Then by selecting the day by use of a curser on the date of the day on the calendar, or other data entry means, the required actions for that day may be addressed.

The colors used in the above example may be changed to suit the user and the meanings of the colors used in the above example are for illustration purposes only as the merchant may signify other events by the use of other colors than were used in the above example.

In one embodiment of the home window 10, as in FIG. 1, the calendar area 12 has two months displayed in the upper left corner of the screen. Different months can be selected by using the curser on corner arrows 13, 14.

When a day is selected on the calendar 12, batches created on that day are shown in a daily batch log grid 20. The daily batch log grid 20 may include the name of the account for the batch, the total amount of the batch and the count of the number of payment instruments in each batch. In the sample shown in the daily batch log grid 20 the names of the accounts are shown. Here the first three accounts and account numbers may represent where the checks are from such as from different stores or different cash registers. The fourth line, at the bottom of the daily batch log grid 20, is an accumulated batch 25 representing the recurring checks that have been processed for the day.

In order to dig down and see the details of a batch in the daily batch log grid 20 the individual batch of interest such as the accumulated batch 25 can be highlighted. The details of the accumulated batch 25 are then shown in the batch detail 27 at the bottom of the home window screen 10. The batch detail 27 shows the amount of each payment instrument in the recurring payments batch, in this case each check the check number, the scanned in or processed time and other data such as customer ID or payment references may be added to the batch detail 27. In order to dig down further in the data, the details for an individual entry in the batch detail 27 may be seen by highlighting the item of interest such as at highlighted item 28. The highlighted batch detail entry 28 is shown above the batch detail 27 as individual item detail 29. Here the check information for the recurring check entered shows the amount of the recurring payment, the bank routing number of the check the bank account number and the check number. Other information such as the memo line on the check may be added to the detailed information of the individual item detail 29. Further data such as the check image 91 and notes 92 can be seen on the single payments screen 90 as shown in FIG. 3 by clicking on the single payments icon 71 on toolbar 60 as shown in FIG. 1.

Also displayed on the home window 10 is the summary view 30 and quick links view 40. The summary view 30 provides information about the status of specific tasks for the day selected. For example in the deposits/payments column the top row shows the Ready to Index data 32. This shows the number of deposits scanned in and ready to index. In the example shown, two items were scanned in and one is ready to be indexed, the total dollar amount indexed so far is zero as shown in the amount column 33. If a task requires attention, it will be highlighted in red and the magnifying glass icon 39 will be shaded indicating it is active. Clicking the magnifying glass icon 39 in the Ready to Index row 32 directs the user to the indexing tasks which need to be performed.

After data is indexed the user may wish to check the data for accuracy by using a quality control step as at Ready to QC in row 34. Any desired quality control checking method may be used such as a double blind entry method or a total amount balance method. In the embodiment shown the screen indicates that no quality control has been conducted and there are no batches ready for a quality control check. Therefore the operator knows that there is no work to be done for quality control on the day selected. Clicking on the associated magnifying glass 39 in Ready to QC row 34 with the curser will direct the user to the quality control that needs to be performed.

After items have been indexed and checked by quality control, if desired, they are ready for deposit and the batch is ready to send in electronically. The Ready to Send row 35 shows that there are two of three deposits ready to send in for deposit. The total amount ready to send in for deposit is $91.32. If a task requires attention, it will be highlighted in red and the magnifying glass icon 39 will be highlighted indicating it is active. Clicking on the magnifying glass icon 39 in the Ready to Send row 35 allows the user to compete the task so that the batch can be sent in for deposit. As shown for the day selected one more check needs to be processed to make it ready to send in for deposit.

The Open Single Checks row 36 indicates there are three checks in the batch detail 27, the first check of the three checks is shown on highlighted line 28. The total of the three checks is $114.00. The actual check image is obtained by clicking on the magnifying glass icon 39 on Open Single Checks row 36.

The Open Single Credit Cards row 37 shows zero deposits of zero credit card slips or payments received. The total of the credit card slips received is $0. An image of the credit card slips may be obtained by clicking on the magnifying glass icon 39 on Open Single Credit Cards row 37.

The quick links view 40 has information on recurring payments to generate, Deposits Sent Today 42 and Unreviewed Returns 44.

The Recurring to Generate row 41 shows the operator how many recurring deposits there are to review for the day selected and how many have been reviewed. In the example in row 41, the first recurring payment is to be processed of two which need to be processed for the day. The recurring payment may be a check generated per the customer's instructions. The processing may involve approving the check for a predetermined amount on a predetermined day, or entering an amount for the day, or entering the date the payment is to be made. If there were recurring payments to be processed the numbers in the recurring to generate box would be colored and the magnifying glass icon 49 would be highlighted. Clicking the curser on the magnifying glass icon 49 on Recurring to Generate row 41 brings the user to the processing of the recurring payments software for processing the payments for the day.

The Deposits Sent Today row 42 shows how many deposits were made on the calendar day selected and how many there are to be deposited. In the sample shown there are no deposits that have been made and no deposits to make. Clicking the curser on the magnifying glass icon 49 on Deposits Sent Today row 42 brings the user to the processing of batch sending software for processing the payments for the day.

The Unreviewed Returns row 44 shows the number of checks or credit card slips that have been returned and not processed or other returns not processed. As shown in FIG. 1 for the calendar day selected, there are no unreviewed returns to process and the total amount of unreviewed items is zero. If there were items to review, the number in the unreviewed box would be read and the magnifying glass icon 49 would be highlighted. Clicking on the magnifying glass 49 for the Unreviewed Returns row 44 would bring the user to the software for viewing and processing the unreviewed returns.

The home window 10 also provides the user with a series of icons on a toolbar 60 at the top of the screen. Home Window icon 61 brings up the home window 10 as shown in FIG. 1. The home window 10 provides a look at the calendar 12, the daily batch log grid 20, the summary view 30 and quick link view 40, the individual item detail section 29 and the batch detail 27. The home window 10 provides a quick view of the status of work that needs to be done for the day.

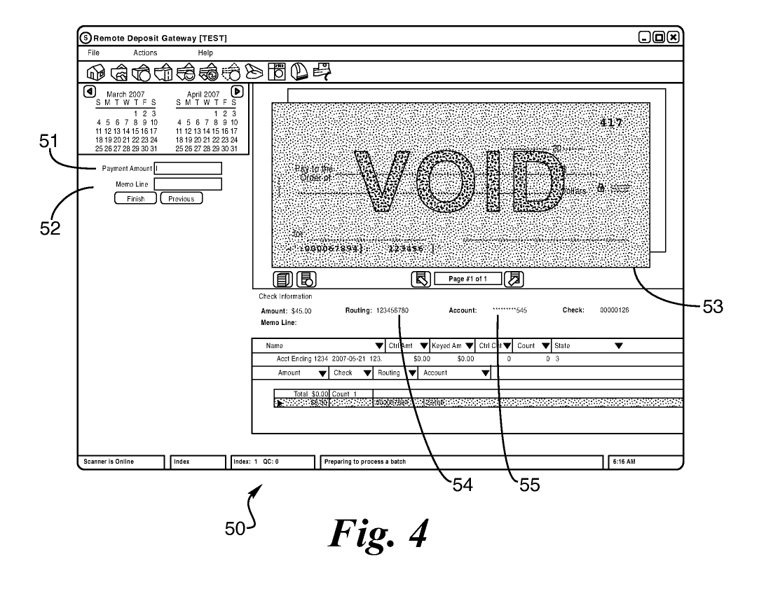

The opens a batch deposit ticket icon 62 starts the scanner to scan all checks in the scanner's hopper. As shown in FIG. 4, a display screen 50 of the checks in the scanned check batch may be used. Each check scanned in has the amount of the check 51 and any memo information 52 indexed into the computer. The check image 53 is captured and the system automatically captures the bank routing number 54 and the account number 55. The total number of checks in the batch shows up in the Ready to Index row 32 and Deposits/Payments column 31 of the summary view section 30 of the home window screen 10 in FIG. 1. It should be noted that remote scanning can also be used to add payments to the batch.

The Add to the Open Batch Toolbar icon 63 adds payments to an open batch. Clicking on the Add to the Open Batch Toolbar icon 63 starts the scanner and adds any additional checks to the current open scan batch. Some scanners limit the number of checks that can be automatically fed through at one time or may only permit scanning one check at a time. If there are additional checks to include in a batch, the scanner can feed through the additional items automatically by using the Add to Open Batch 63 feature. This feature adds items to the current open batch. Once the Add To Open Batch icon 63 is selected, the scanner will start scanning and add additional checks to the current open batch of scanned items.

Close Batch icon 64 is used after all payment items are added to the batch. The batch will then need to be closed. An open batch will not display in the daily batch log grid 20 nor will it be able to be transmitted for processing until it is closed.

The Delete a Payment icon 65 allows the user to delete a selected payment from the batch. This is only available during the scan step or during a process step. Once a batch deposit ticket has been indexed, the option will not be available to remove a payment. If the item is deleted, the item needs to be recreated in a new batch.

The Process the Next Batch icon 66 invokes the next process step for the oldest batch available. This ensures that when multiple scan stations are creating tickets, the oldest scan batches are processed first. If no batches are ready for processing, a message to that effect is displayed in the status bar at the bottom of the screen. The next process step after scanning is indexing the data from the payment tickets, which can be checks or credit card slips. Indexing is accomplished by entering data such as the check amount or charge amount into the data base and any other information which may be required.

The Delete the Entire Batch icon 67 allows the user to delete the entire batch, whereby all information is deleted and the entire batch must be re-scanned. This action is only available for the current active batch and only during the indexing and quality control processes.

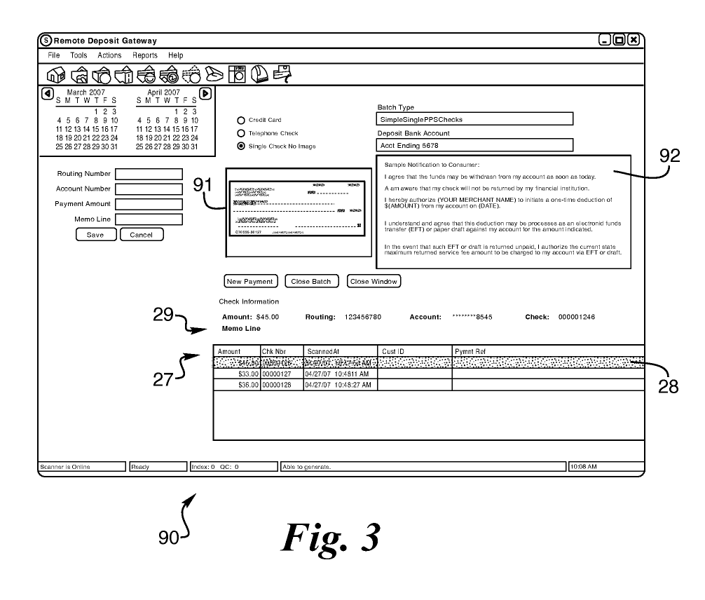

The Transmit Batch icon 68 displays a list of all scanned but not sent batches 82, allowing them to be grouped into a single deposit ticket and transmitting them for processing as shown on the batch manager screen 80 in FIG. 2. Various batches can be highlighted. Note that the details at the top of the batch manager screen 80 are updated to show what has been selected. The Transmit Batch icon 68 also invokes all configured exporters to create input files for various purposes. When the Send button 84 is clicked, all the selected batches are consolidated into a single deposit ticket using the name of the most recent selected batch. The total details for the consolidated batch are updated, and all sent batches are removed from the Batch Manager screen 80.

The Review Processor Status icon 69 is a direct link to a merchant reporting system. From this page, the status of deposit transmissions can be verified.

The Reset the Scanner icon 70 resets the scanner by sending a hard reset command. This can be used if the scanner is not responding.

The last icon on the toolbar 60 is the Single Payment icon 71 which brings up the Single Payment screen 90 as in FIG. 3. There are three types of single payments: credit card, telephone check and single check no-image. All three single payment types use the same user interface and follow the same sets for creating payments and batches. Each type is in a separate batch.

A credit card payment can be entered as a one time payment from a credit card recurring payment since the information about the card and the payment are already on the database, or the card information can be added to the database for a one time charge. Similarly for a telephone check, a customer can call in and authorize a check to be made out against his bank account on the phone. If the customer has provided a check for a recurring check payment which has already been scanned in or has provided a check for the one time payment the check can be scanned in to obtain the account number and bank routing number. Otherwise the bank account number and bank routing number have to be provided by the customer and entered into the system. In the preferred embodiment a single payment can be entered as a one time payment on the recurring payment page or on the single payment page.

When a calendar day is selected, such as by placing the curser on a date on the calendar 12, high speed SQL (Structured Query Language) database queries gather the required summary information and based on that information, hint text is created and the color is determined for the days on the calendar. Each day may be color coded based on the user's preference and shows at a glance the following information: the number of payments, the number of individual deposits, and dollar total of all payments. The color codes for each day show the status such as, no activity today, all deposits successfully posted for a day, some deposits awaiting processing for a day, At least one returned item found for a day and not yet reviewed and at least one returned item found for a day that has been reviewed.

Hint text is created when the curser is placed on a line of information, such as at the daily batch log grid line 25, where a temporary bubble will appear on the screen indicating the display batch status and the date and time sent, if it was sent, for about 20 seconds and then fades out.

Upon activation of the specific day, another series of high speed SQL database queries are executed to determine the list of batches for the day. The summary information is stored with the batch records, so no additional database queries are required to create the hint text.

Upon activation of a single batch, the details for that batch are retrieved and cached in the local workstation memory so that subsequent paging through the details is very fast.

All sensitive data (including images) are stored encrypted in the database and each database has a unique encryption key so that data is never compromised.

Once the data is entered into the system the user can see at a glance the status of the accounts and the work that needs to be done.

An application wizard allows setup of an unlimited number of “batch types”, each with its own unique list of fields to capture. Then, when a transaction is entered for the selected batch type, a data entry panel is dynamically created with the requested fields. This data is stored along with each transaction and is then used to export into the requested format. When a batch is submitted for deposit, the configured fields are formatted based on the business rules of the desired export, and a file is written to a pre-configured directory containing all of the requested information for each batch. This file is then available for use by an external system.

This feature allows customization that is wizard driven and potentially saves the client significant programming dollars. Other similar applications have fixed data entry fields and require professional services and programming to change or add data entry fields. The application gives each individual client the ability to choose for their business processes the exact data fields to collect the exact information required. Then, they are able to choose which data fields to export and custom map them to the data fields within their ERP (Enterprise Resource Planning), CRM (Customer Relationship Management), or accounting software without additional programming. This allows for data to interface to any other software with an Import Functionality. These features provide a unique and custom application to any business without additional programming.

The Remote Deposit Gateway has an image to data field mapper. This application can image checks and corresponding remittance forms (coupons, order forms, etc.). Combined with the dynamic data entry, each custom field can be associated with a specified imaged document. Upon entry into each custom field, the specified document appears on the screen next to the data entry area without operator intervention. Batch types are configured using our batch type definition editor. Part of this editor captures how many pages are in an individual document, and in what order they are contained. Then, when data entry fields are defined, the administrator simply designates which page of the multi-page document contains the data that must be captured. At run time, this definition is used to automatically page the correct image into the image window so that the operator can easily find the data needed to index data in the desired fields. Data entry and the time it takes for businesses to enter this data is a critical cost component of any back office. With the ability to streamline data entry, businesses can save time when the custom data field is mapped to the image file where the data will be entered thus providing a high speed data entry environment.

The Remote Deposit Gateway has an integrated returns feature as part of the remittance processing. There are various reasons for returns including account closed and non-sufficient funds. This application allows the operator to retrieve the return information from the third party payment processor and integrate it into the existing database. The smart calendar is highlighted in red and the home window 10 displays outstanding task items when returns are present. The operator then has the ability to act on this returned data based on internal business policies and processes. Our dynamically configured host integration module contains a “callback” for fetching returned items from the host database. Based on key data from this callback, the original transaction is identified and a returns pointer is inserted into the database.

The Remote Deposit Gateway has a smart account alerts feature. Smart account alerts are small notes or alerts that are tied to a specific account. These alerts are then integrated into the dynamic data entry screens whenever a check item is scanned for the account of concern, or a single payment is made for that account. These alerts are used to either specify potential issues with the account holder, or to highlight expedited processing such as a VIP note. This alert function is also critical for giving the account holder “Opt Out” ability to meet the NACHA requirements for ARC (Accounts Receivable Conversion) processing. NACHA develops operating rules and business practices for the Automated Clearing House (ACH) Network and for electronic payment processing, including ARC check conversion for personal checks. From any payment screen, an alert can be generated that will automatically be tied to the displayed payment. Then, while in data entry mode, if the account and routing number (or just account number for a credit card) are encountered, the specific alert message is displayed to the data entry operator as the first line of the dynamically created data entry screen. The smart account alerts feature is an important mechanism for managing customer information at the time of payment entry. Enabling operators to make informed decisions about payments prior to sending is a key advantage. This can save time in business processes while reducing the number of returned items. Alerts are also able to instruct non-payment activity within the organization. This alert function also allows ARC (ACH type) electronic check conversion requirements to be maintained.

The Remote Deposit Gateway has a data entry field check sum. When a batch type is configured for control checks, a data entry panel appears at the start of the initial index step requiring the operator to enter the pre-calculated total amount of the batch as well as the number of documents in the batch. When the batch is finished, the running count and totals are compared against the pre-entered control information and the operator is informed of any mismatch. If the item is mismatched, the operator can either accept the keyed information, or go back to correct the items in error. Blind keying allows for any data entry field to be designated as a blind field during batch field definition. Then, when an operator keys the data for the second time, the original keyed data is compared to the re-key and if they do not match, the operator is given the chance to correct the issue or accept the newly corrected information. This feature gives the operator the ability to provide data entry steps that actually check against known and pre-entered information. If data entry personnel enter the data correctly and it passes the check sum, then the operator is allowed to move forward. If the check sum data fails, then the data entry operator is required to make corrections. This provides assurances of high speed data entry accuracy and “must have” data requirements, reduces back office mistakes and reduces costs associated with correcting mistakes in the data entry process.

The recurring payments module gives the business complete control of the data management and maintenance of the recurring schedule. The recurring payments module allows the choice of recurring payments from a credit card or a bank account. The recurring payments module also allows the ability to create a recurring payment schedule from an existing check image within the system, from an existing ACH record or from an existing record of a credit card payment.

After the type of payment is chosen the number of payments to make is selected. The recurring payments module allows any fixed number of payments to be selected or to allow a string of payments that never expires unless the customer chooses to end the payments.

All the modules, including the recurring payments module, can be set up with custom data entry fields. These help the operator collect and associate data for the customer/payer that can be later exported into other systems and/or added to search functionality.

The recurring payments module may be set up to allow a choice of any payment cycle with choice of first payment date. Both dates do not have to be identical. For example, it is possible to let a customer have money come out of their account on the fifteenth of each month, but the first payment will be initiated on the eighteenth of the current month.

The recurring payments module has the ability to extend the number of payments after the schedule has been set up. The recurring payments module also allows a one time override of the payment amount. For example, if the customer has a fixed payment amount each month but requires a one time additional payment on a given month, the system will generate this override total amount with an operator input, the system will then charge the override total, and then revert back to the regularly scheduled amount the following month without operator intervention.

The recurring payments module has the ability to change the next payment date on a customer's account. For example if the customer mutually agrees with the operator to change or suspend the next payment date. Once the new date has been set the system will not generate the payment until the new date without operator intervention.

The recurring payments module has the ability to expire the account.

The recurring payments module has the ability to maintain the account, allowing the operator to edit any and all information on the recurring schedule. Thus, the operator can change the account holder information such as which bank account to withdraw funds from, and the regular scheduled frequency or date of payment. The operator can also review the payment history of each individual schedule. The operator can create special one time payments from existing account holder information or view the original check image when setting up a payment from a paper check initiated payment.

All the modules including the recurring payments module also allow full search functionality with the ability to export data into Excel.

In the recurring payments module the insertion of a returns pointer causes the various SQL algorithms to be invoked when loading the smart calendar. The smart calendar then colors the day, the batch and the item with the user selected color for an un-reviewed return. Once an operator reviews a return, any annotation made is saved (along with their identification) with the return pointer and subsequently displayed upon re-review of the returned item. By integrating the returns back into the application, and providing the operator options for dealing with the returns, the collection process for returned items is streamlined while giving historical data for the operator to make informed decisions on the payer in the future.

Preferably the integrated returns module has the ability to set custom alerts which helps in processing returns by providing needed information about the account. The module provides the ability to mark each item as reviewed which helps for long term identification and records. This also activates the smart calendar and changes the color on the specific date of the returned item and within the batch that contained the returned item.

The integrated returns module has a return code displayed when the mouse pointer is on the item detail as a balloon pop-up. This gives the user the common name for the return code, the date of the return and the date of when it is reported.

The integrated returns module has the ability to attach a custom note with a system generated name and time stamp.

A recurring payment template wizard creates and maintains a customer's payments. All changes are done to a “template” and are available for the next cycle of payment generation. Every time a payment is generated, the next “due date” is calculated, but no payment details are created until that “due date” has been reached. When payments are due, the operator is notified with a scrolling marquee message which prompts them to generate the payments. Generated payments are then treated the same as any scanned or single-entered payments. All payments are the same and can be included or excluded from deposit batches.

Obviously, many modifications and variations of the present invention are possible in light of the above teachings. It is therefore to be understood that, within the scope of the appended claims, the invention may be practiced otherwise than as specifically described.

What is claimed is:

1. A calendar based funds transfer management system comprising:
software for generating a calendar having the days of a month shown on a computer monitor,
a data base storing account information on the computer,
a structured query language software running on the computer to compile color codes for the days on the calendar based on the account information and displaying the color codes on the calendar.

2. A calendar based funds transfer management system as in claim 1 wherein,
a day selected on the calendar brings up a screen providing data from the database about the day selected.

3. A calendar based funds transfer management system as in claim 1 wherein,
a color is associated with all transactions completed for the day placed on the calendar.

4. A calendar based funds transfer management system as in claim 1 wherein,
a color is associated with returns to process for the day placed on the calendar.

5. A calendar based funds transfer management system as in claim 1 wherein,
a color is associated with recurring payments to process for the day placed on the calendar.

6. A calendar based funds transfer management system as in claim 1 wherein,
a color is associated with payment tickets to process for the day placed on the calendar.

7. A calendar based funds transfer management system as in claim 1 wherein,
a color is associated with indexing to process for the day placed on the calendar.

8. A calendar based funds transfer management system as in claim 1 wherein,
a color is associated with batches to process for the day placed on the calendar.

9. A calendar based funds transfer management system as in claim 1 wherein,
a color is associated with no payment tickets received for processing for the day placed on the calendar.

10. A calendar based funds transfer management system as in claim 1 wherein,
a color is associated with some action for processing needs to be performed for the day placed on the calendar.

11. A calendar based funds transfer management system as in claim 2 wherein, a daily batch log is displayed.

12. A calendar based funds transfer management system as in claim 2 wherein, a batch is displayed.

13. A calendar based funds transfer management system as in claim 2 wherein, ready to index data is displayed.

14. A calendar based funds transfer management system as in claim 2 wherein, ready to quality control detail is displayed.

15. A calendar based funds transfer management system as in claim 2 wherein, ready to send data is displayed.

16. A calendar based funds transfer management system as in claim 2 wherein, open single checks data detail is displayed.

17. A calendar based funds transfer management system as in claim 2 wherein, single credit card slips to send data is displayed.

18. A calendar based funds transfer management system as in claim 2 wherein, returns data is displayed.

19. A calendar based funds transfer management system as in claim 2 wherein, recurring data is displayed.

20. A calendar based funds transfer management system as in claim 2 wherein, deposits data is displayed.

21. A calendar based funds transfer management system as in claim 2 wherein, unreviewed returns data is displayed.

21. A calendar based funds transfer management system as in claim 2 wherein, selecting the calendar day permits processing of tasks for that day.

22. A calendar based funds transfer management system as in claim 21 wherein, selecting an icon on the screen elects scanning payment tickets.

23. A calendar based funds transfer management system as in claim 21 wherein, selecting an icon on the screen elects indexing payment tickets.

24. A calendar based funds transfer management system as in claim 21 wherein, selecting an icon on the screen elects adding payment tickets to a batch.

25. A calendar based funds transfer management system as in claim 21 wherein, selecting an icon on the screen elects transmitting batches of payment tickets for payment.

26. A calendar based funds transfer management system as in claim 21 wherein, selecting an icon on the screen elects processing recurring payment tickets.
